(19) United States
(12) Patent Application Publication
(10) Pub. No.: US 2002/0071030 A1
(43) Pub. Date: Jun. 13, 2002

(54) Implementation of media sensor and segment descriptor in ISO/IEC 14496-5 (MPEG-4 reference software)

(76) Inventor: Zvi Lifshitz, Jerusalem (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 09/978,566

(22) Filed: Oct. 18, 2001

Related U.S. Application Data
(60) Provisional application No. 60/241,732, filed on Oct. 19, 2000.

(51) Int. Cl. H04N 5/253

(52) U.S. Cl. 348/100; 348/101

(57) ABSTRACT

An implementation of stream segments and media sensors in the reference software of MPEG-4 ISO/MEC 14496-5, is presented. In some embodiments, the implementation involves the definition of a new class in the Core module, namely segmentDescriptor, and new fields and methods in existing classes in the Core module. The implementation requires few changes to the source code of the Renderer module.

### CROSS-REFERENCE TO RELATED APPLICATIONS

The present application claims priority from U.S. provisional application serial No. 60/241,732, filed Oct. 19, 2000, which is hereby incorporated by reference.

### BACKGROUND OF THE INVENTION

ISO/IEC 14496, commonly referred to as “MPEG-4”, is an international standard for the communication of interactive audio-visual scenes. Part 1 of the standard includes specifications for the description of a scene graph comprising one or more audio-visual objects. Part 5 of the standard includes a software implementation of the specifications in be form of an MPEG-4 player. An MPEG-4 player parses a bitstream containing a scene description, constructs the scene graph, and renders the scene.

Part 5 of the NPEG-4 standard (ISO/IEC 14496-5) provides reference software that implements different aspects of the MPEG-4 specification. The portion of the reference software that implements Part 1 of the standard is known as “IM1” and includes several modules. The Core module parses scene description bitstreams, constructs the memory structure of the scene graph, and prepares the scene graph for the Renderer module, which traverses the scene graph and renders it on the terminal hardware (e.g., screen, speaker). The Core and the Renderer are implemented as separate modules, typically by different parties.

Amendment 2 to ISO/IEC 14496-1 introduces media sensors and stream segments. Prior to this version, the Renderer module would display an entire elementary stream of an audio-visual object, for example an audio stream or a video stream, from start to finish. Stream segments were introduced to enable an MPEG-4 player to play selected segments of an audio-visual object. Media sensors were introduced to monitor the status of playback of an elementary stream. It would be beneficial to implement these new features in the MPEG-4 reference software with few changes to the code.

### BRIEF DESCRIPTION OF THE DRAWINGS

The subject matter regarded as he invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a simplified pictorial illustration of an exemplary IM1 architecture, according to some embodiments of the present invention; and

FIG. 2 is a simplified pictorial illustration of an exemplary IM1 architecture, according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known modules, classes, methods and fields have not been described in detail so as not to obscure the present invention.

The detailed description that follows refers specifically to the IM1 implementation of the ISO/IEC 14496-1 standard and therefore mentions class, field and method names that are used by his implementation. However, the IM1 algorithms may have other implementations with different names. Hence class, field and method names are quoted in this detailed description only for the purpose of facilitating the discussion and are not considered a material part of the technology.

Moreover, IM1 is written in C++. However, it will be appreciated that the following description may be adapted to any object-oriented language.

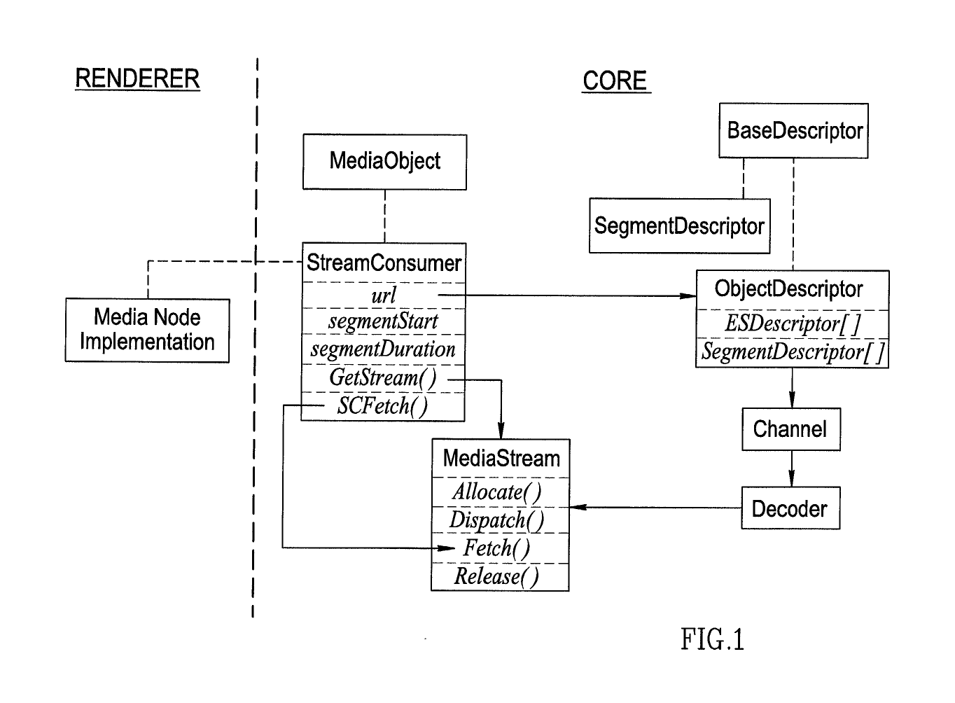

Reference is now made to FIG. 1, which is a simplified pictorial illustration of an exemplary IM1 architecture, according to some embodiments of the present invention.

The architecture shown in FIG. 1 includes the following classes from the existing IM1 Core module, which will be described only briefly;

| | |
|---|---|
| MediaObject | a base class for scene nodes |
| StreamConsumer | a class that implements tasks specific to media streams |
| BaseDescriptor | a base class for object description framework |
| | descriptors |
| ObjectDescriptor | a class for object description framework descriptors |
| ESDescriptor | a class for elementary stream descriptors |
| MediaStream | a class that handles buffer management |
| Channel | a class for stream channels |
| Decoder | a class for media decoders |

The architecture shown in FIG. 1 also includes a class from the Renderer module, namely a Media Node Implementation class. Nodes are the entities in the scene graph that represent audio-visual objects. Each node is of a specific node type, represting elements such as lines, squares, circles, video clips, audio clips, sensors, etc. As mentioned hereinabove, MediaObject is the base class for scene nodes. Each node is derived from MediaObject and extends it by adding definitions for the specific fields of the node. The Renderer then extends each node type further, adding rendering code for each node type. Rendering is accomplished by letting each node render itself as the scene graph is traversed.

Media nodes are one type of nodes that handle content coming through elementary streams, While some nodes derive directly from MediaObject, media nodes derive from StreamConsumer, which derives from MediaObject. StreamConsumer implements tasks that are specific to media streams, including open/close of stream channels, instantiation of media decoders, and buffer management for each stream. An example of a Media Node Implementation class is MovieTexture, which displays a video track as part of a scene.

An object descriptor is a collection of one or more elementary stream descriptors that provide the configuration add other information for the streams that relate to either an audio-visual object or a scene description. Each object descriptor is assigned an identifier (“odid”), which is unique within a defined name scope. This identifier is used to associate audio-visual objects in the scene description with a particular object descriptor, and thus with the elementary streams related to that particular object.

Elementary stream descriptors include information about the source of the stream data, in the form of a unique numeric identifier (the elementary stream ID) or a URL pointing to a remote source for the stream Elementary stream descriptors also include information about the encoding format, configuration information for the decoding process and the sync layer packetization, as well as quality of service requirements for the transmission of the stream and intellectual property identification.

MediaStream is a class that implements first-in-first-out (FIFO) buffer management. It also provides a mechanism for synchronizing the presentation of media units. Each MediaStream object is accessed by two entities, a sender and a receiver. The sender stores media mats in the buffer, while the receiver fetches them in FIFO order. The main methods of MediaStream are:

Allocate allocate buffer space for the storage of a media unit

Dispatch signal that a media unit is ready for fetching on the buffer

Fetch fetch one media unit from the buffer (this method also handles synchronization—the receiver can request to get next media unit only when its presentation time has arrived)

Release signal that the last fetched media unit can be discarded from the buffer

In IM1, a media node is implemented as a StreamConsumer object. This object has an url field that, prior to the implementation of Amendment 2, consists only of an identifier of an object descriptor, in the format “odid”. The object descriptor is implemented as an ObjectDescriptor object. The player uses this object to create a channel and instantiate a decoder. The elementary se data is received through the channel, decoded by the decoder and dispatched to a MediaStream object. The Renderer module implements the node rendering by deriving from StreamConsumer. It uses the GetStream method to get a handle to the MediaStream object, and then uses the MediaStream object's Fetch method to retrieve media units from the buffer. When rendered the media node displays an entire elementary stream of an audio-visual object, for example an audio stream or a video stream, from start to finish.

Amendment 2 to ISO/IEC 14496-1 introduces stream segments so that an MPEG-4 player may play selected segments of an audio-visual object. According to this Amendment, an url field may refer to a segment of an elementary stream by using the format “odid.segmentName”.

According to some embodiments of the present invention, a new class, SegmentDescriptor, is defined. As shown in FIG. 1, SegmentDescriptor derives from BaseDescriptor and an array of this class is added as a field in ObjectDescriptor.

According to some embodiments of the present invention, new fields, for example segmentStart and segmentDuration, are added to StreamConsumer in order to provide storage of the timing information of segments of an object. If the url field of a media node includes segment names, then during rendering of the media node the timing information of the segments is retrieved and stored on the StreamConsumer object in these new fields.

According to some embodiments of the present invention, a new method is added to StreamConsumer. It may be called SCFetch, for example, and it receives all the arguments of the Fetch method of MediaStream. This method activates the Fetch method of MediaStream, checks the time stamps of the fetched media units, and discards all media units that are not in the segment range.

To use this new functionality, all the code of the Renderer needs to be changed so that all calls to GetStream.( )->Fetch( ) are replaced by SCFetch( ), In other words, when a media node needs to fetch a media unit from the buffer, it calls its own SCFetch method (which it inherits from StreamConsumer) rather than calling the one defined for MediaStream. This change is required at the source code, but it puts very little burden on the developers of the Renderer. In fact, it may be accomplished by a global “find and replace” command and recompiling. According to some embodiments of the present invention, no other source code changes are required in the Renderer in order to implement stream segments.

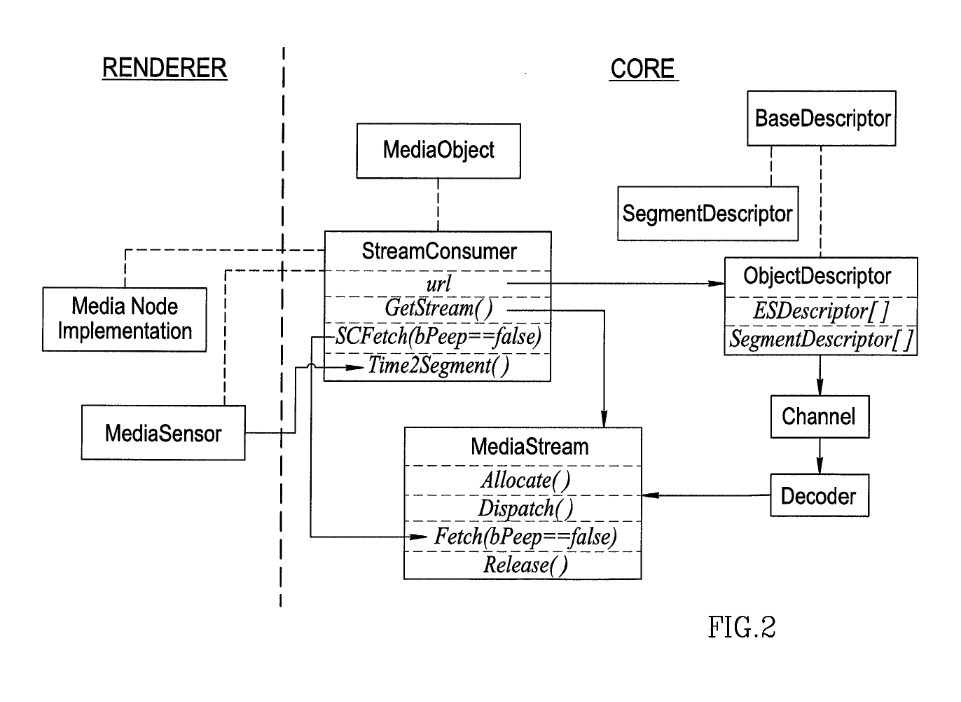

Reference is now made to FIG. 2, which is a simplified pictorial illustration of an exemplary IM1 architecture, according to some embodiments of the present invention.

Amendment 2 of ISO/IEC 14496-1 introduces a new node type, MediaSensor, that is used to monitor the playback status of an elementary stream. A media sensor generates events when a stream or segment of it starts or ends, and also reports the timestamp of every stream unit that is currently being played.

According to some embodiments of the present invention, a new Boolean parameter, called bPeep for example, is added to the Fetch method of MediaStream and to the SCFetch method of StreamConsumer. It may be assigned a default value of false, so none of the existing references to this method may need to be changed.

However, when the argument is true, the method returns the same values as the normal method would, but does not affect the state of the object. In other words, all media units in the buffer are still available for retrieval by other nodes. Using the method with the argument bPeep having a value of true, a MediaSensor object knows the exact status of the stream, that is the time stamp of the media unit that is available for display at each moment, without affecting the normal execution of the Renderer.

According to some embodiments of the present invention, a new method is added to StreamConsumer. It may be called Time2Segment, for example. Given a time stamp, this method examines the segment description data associated with the object and determines which segment is now playing. This information is stored in appropriate MediaSensor fields (not shown) that are part of the standard and are described in Amendment 2 to ISO/IEC 14496. These MediaSensor fields, like all other node fields, ran be routed to other nodes to tiger behavior expected by the content creator.

While certain features of the invention have been illustrated and described herein, many modifications, substitutions, changes, and equivalents will now occur to those of ordinary sill in the art. It is, therefore, to be understood that the appended claims are intended to cover all such modifications and changes as fall within the true spirit of the invention.

What is claimed is:

1. A method of SegmentDescriptor implementation in ISO/IEC 14496-5 comprising:
defining a SegmentDescriptor class that derives from BaseDescriptor;
adding an array of SegmentDescriptor objects to ObjectDescriptor; and
adding an object method to StreamConsumer that activates a Fetch method of MediaStream, checks time stamps of fetched media units and discards all media units that are not in a range of a specified segment.

2. The method of claim 1, further comprising:
replacing one or more calls to GetStream->Fetch in source code of a Renderer module with calls to said object method.

3. A method of MediaSensor implementation in ISO/IEC 14496-5 comprising:
defining a MediaSensor class that derives from StreamConsumer;
adding an object method to StreamConsumer that activates a Fetch method of MediaStream, checks time stamps of fetched media units and discards all media units that are not in a range of a specified segment;
adding a parameter to said object method and to said Fetch method so that when said parameter has a predefined value, calls to said object method and to said Fetch method return normal results but do not affect the availability of media units in a buffer of a MediaStream object.

4. The method of claim 3, fiber comprising:
adding an object method to StreamConsumer that given a time stamp determines which segment of a stream whose media units are stored in said buffer is now playing.

5. An implementation of SegmentDescriptor in a Core module of ISO/IEC 14496-5 that requires only a global find-and-replace in source code of a Renderer module of ISO/IEC 14496-5 and recompilation of said source code.
